(19) United States
(12) Patent Application Publication
(10) Pub. No.: US 2013/0069736 A1
(43) Pub. Date: Mar. 21, 2013

(54) BALUNS WITH IMAGINARY COMMOND-MODE IMPEDANCE

(71) Applicants: Tzong-Lin Wu, Taipei (TW); Chung-Hao Tsai, Taipei (TW)

(72) Inventors: Tzong-Lin Wu, Taipei (TW); Chung-Hao Tsai, Taipei (TW)

(73) Assignee: National Taiwan University, Taipei (TW)

(21) Appl. No.: 13/451,818

(22) Filed: Apr. 20, 2012

(30) Foreign Application Priority Data
Sep. 21, 2011 (TW) 100133852

(51) Int. Cl. H01P 5/10

(52) U.S. Cl. 333/26

(57) ABSTRACT

Baluns with imaginary common-mode impedance are disclosed. A disclosed balun comprises an unbalanced port with an unbalanced terminal and a ground terminal, a balanced port with two balanced terminals opposite to each other in phase, and a transmission cell. The transmission cell has a differential transmission line, a virtually-ground patch, a ground conductor, and a conductive structure. The differential transmission line has a pair of conductive traces spaced apart from each other, and is electrically connected between the unbalanced port and the balanced port to transmit a differential signal. The virtually-ground patch is spaced apart from the differential transmission line. The conductive structure electrically connects the virtually-ground patch to the ground conductor.

### BACKGROUND

The present disclosure relates generally to baluns that convert electrical signals balanced with respect to ground (differential) to signals unbalanced (single-ended), and the reverse, and, more particularly, to compact baluns that have imaginary common-mode impedance and could be formed using low temperature co-fired ceramic fabrication technology or lumped devices.

Baluns are important components in balanced circuit topologies, such as balanced mixers, push-pull amplifiers, and dipole feeds. They are also applied to convert or match the unbalanced single signal to balanced differential signals. Baluns are mainly classified into two types, passive and active baluns. Although active baluns can attain better performance than the passive ones in view of product size and phase balancing, extra power consumption is needed, such that active ones may not be suitable for the applications of modern wireless and mobile communication systems. Today's electronic products prefer using system-in-package (SiP) technology and require compactness, multi-functionality, and power saving. Therefore, designing a passive balun with broadband operation and small size in SiP has been a new challenge.

Many planar balun configurations were proposed at microwave frequencies. Distributed transmission line baluns, including Marchand baluns and coupled-line baluns, are the most popular methods. Marchand balun basically consists of four transmission line sections, where one is unbalanced, another is open-circuited, and the rests are short-circuited and balanced. Each transmission line section is about quarter-wavelength long. A coupled line balun comprises several cascaded coupled line sections of quarter-wavelength. Because multiple quarter-wavelength sections have to be applied, these two methods will occupy a larger area. As a result, baluns combining the distributed transmission line with lumped elements are presented. The lumped elements are added at the load end of coupled lines to reduce their electric length. Although they can be designed with a compact size, addition of lumped elements means extra cost and their size still depends on the operating frequency.

### SUMMARY

Embodiments of the present invention include a balun, comprising an unbalanced port with an unbalanced terminal and a ground terminal, a balanced port with two balanced terminals opposite to each other in phase, and a transmission cell. The transmission cell has a differential transmission line, a virtually-ground patch, a ground conductor, and a conductive structure. The differential transmission line has a pair of conductive traces spaced apart from each other, and is electrically connected between the unbalanced port and the balanced port to transmit a differential signal. The virtually-ground patch is spaced apart from the differential transmission line. The conductive structure electrically connects the virtually-ground patch to the ground conductor.

Embodiments of the present invention include a balun, comprising an unbalanced port with an unbalanced terminal and a ground terminal, a balanced port with two balanced terminals opposite to each other in phase, and a transmission cell. The transmission cell has first, second, third and fourth nodes, two first inductively-coupled inductors, a first capacitor, two second inductively-coupled inductors, a second capacitor, third and fourth capacitors, a fifth capacitor and a grounding inductive. The first, second, third and fourth nodes are electrically connected to the unbalanced terminal, the ground terminal, and the two balanced terminals, respectively. The two first inductively-coupled inductors are connected to a first common node and in series between the first and third nodes. The first capacitor is connected between the first and third nodes. The two second inductively-coupled inductors are connected to a second common node and in series between the second and fourth nodes. The second capacitor is connected between the second and fourth nodes. The third and fourth capacitors are connected to a virtually-ground node and in series between the first and second common nodes. The fifth capacitor and a grounding inductive are connected in parallel between the virtually-ground node and the ground terminal.

### BRIEF DESCRIPTION OF THE DRAWINGS

The invention can be more fully understood by the subsequent detailed description and examples with references made to the accompanying drawings, wherein:

FIG. 1 demonstrates a balun according to one embodiment of the invention;

FIG. 2 exemplifies the structure of a transmission cell;

FIGS. 3A and 3B demonstrate top and perspective views of a transmission cell;

FIG. 4 demonstrates two adjacent transmission cells;

FIG. 5 shows one section T-type circuit corresponding to the configuration in FIGS. 3A and 3B;

FIG. 6 demonstrates a transmission cell of another kind, which, in one embodiment, could embody one or more transmission cells of FIG. 1;

FIG. 7 demonstrates a balun according to another embodiment of the invention;

FIG. 8 demonstrates a further balun according to another embodiment of the invention; and

FIG. 9 demonstrates a balun with lumped elements according to another embodiment of the invention.

### DETAILED DESCRIPTION

In the specification, the devices with the same symbol have the same or similar function, structure, or application, but need not be the same in every aspect. Persons skilled in the art can alter or modify the devices or methods disclosed in the specification based on the teaching therein to embody the invention, such that the disclosed embodiments are not for limiting the scope of the invention.

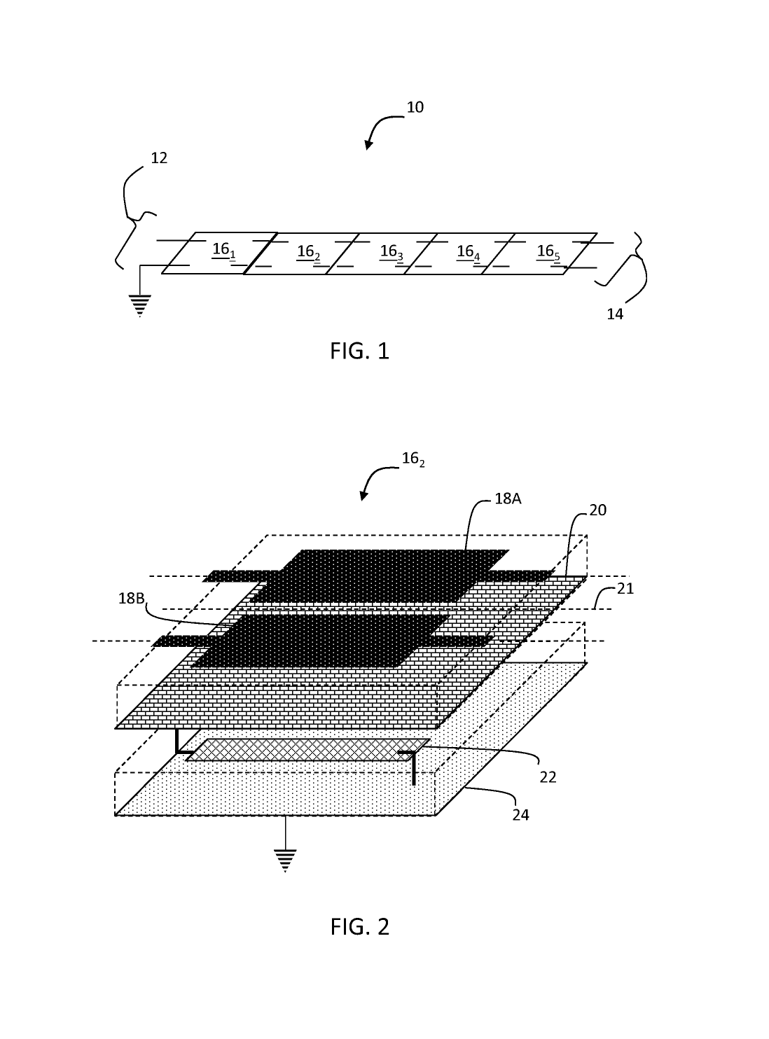

FIG. 1 demonstrates balun 10 according to one embodiment of the invention. Balun 10 has two ports, including unbalanced port 12 and balanced port 14. Unbalanced port 10 has a ground terminal (constantly connected to a ground voltage level) and an unbalanced terminal, while balanced port 12 has two balanced terminals, which receive or output differential signals respectively, opposite to each other in phase. Cascaded between unbalanced port 12 and balanced port 14 are five transmission cells 16₁˜16₅, whose total number would vary in another embodiment. For example, there might be only one transmission cell in another embodiment. As shown in FIG. 1, transmission cell 16₁ is electrically connected to unbalanced port 12, and transmission cell 16₅ to balanced port 14. In one embodiment, balun 10 is formed on a low temperature co-fired ceramic (LTCC) substrate with a multi-layered topology.

FIG. 2 exemplifies the structure of transmission cell 16₂. Other transmission cells might be the same or similar with transmission cell 16₂, such that their details are omitted for brevity because they can be derived or acknowledged based on the teaching of FIG. 2.

In FIG. 2, transmission cell 16₂ has a stacked structure, comprising, from top to bottom, a differential transmission line with conductive traces 18A and 18B, virtually-ground patch 20, conductive structure 22 and ground plane 24. While spaced apart from each other, conductive traces 18A and 18B have corresponding patterns symmetrical to each other with respect to centerline 21 extending parallel to the signal propagation direction. Conductive traces 18A and 18B might consist of traces on a single metal layer, or traces of multiple metal layers using vias for interconnection. Dielectric material spaces conductive traces 18A and 18B apart from virtually-ground patch 20. The two left ends of the differential transmission line in FIG. 2 are electrically connected via transmission cell 16₁ to unbalanced port 12, while the two right ones are electrically connected via transmission cells 16₃˜16₅ to balanced port 14.

Virtually-ground patch 20 could be a patch in a metal layer. Ground plane 24 is a large plate in another metal layer and is constantly shorted to a ground voltage level. In one embodiment, in view of the patterns of the metal layer where virtually-ground patches are formed, the virtually-ground patches of two different transmission cells might be separated from each other. In another embodiment, these virtually-ground patches on a common metal layer might be shorted to each other via conductive traces on the common metal layer. Ground plane 24 of transmission cell 16₂ might extend along a metal layer to also function as the ground plane of an adjacent transmission cell. Ground plane 24 might be replaced, in one embodiment, by a ground conductor that is composed of conductors of different metal layers and electrically connected to a ground voltage.

Conductive structure 22 has a serpent-like topology, physically meandering between and electrically connecting virtually-ground patch 20 to ground plane 24 to form parasitic inductors and capacitors. For example, conductive structure 22 might have conductive vias and spiral metal traces to electrically short virtually-ground patch 20 to ground plane 24.

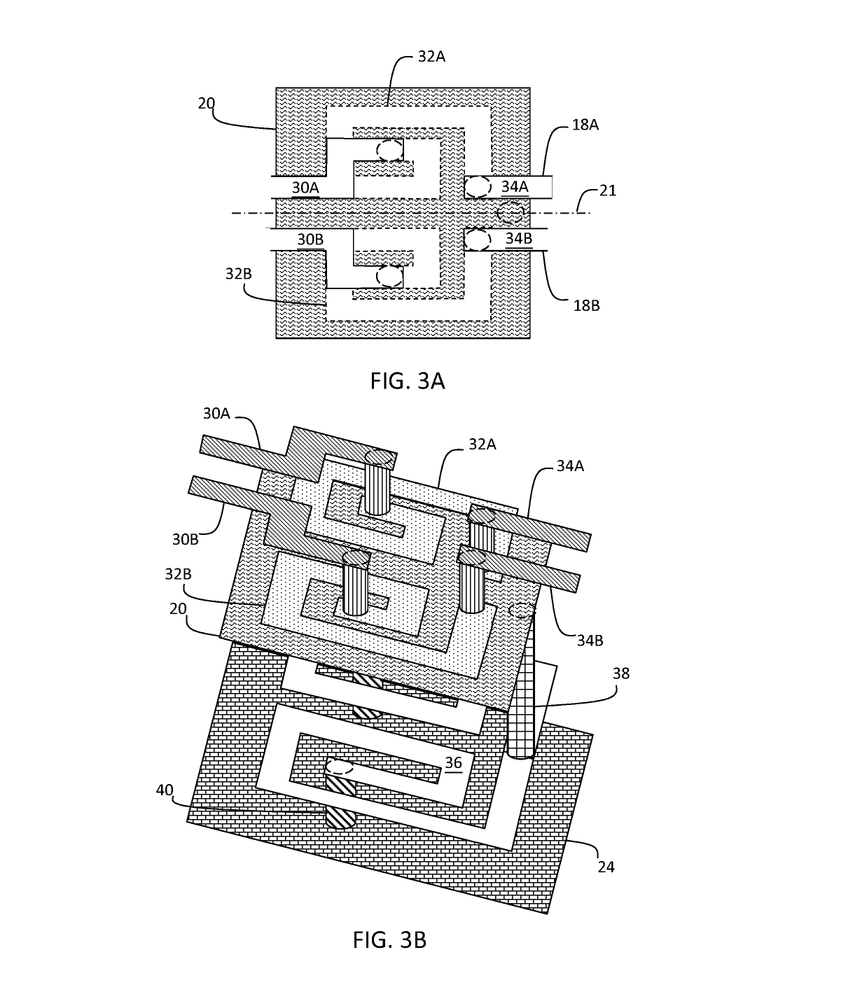

FIGS. 3A and 3B demonstrate top and perspective views of transmission cell 16₂ respectively. It can be found from FIGS. 3A and 3B that conductive trace 18A is composed of conductive vias and microstrip lines 30A, 32A, and 34A at the top two metal layers, forming a spiral routing with one and half turns. Symmetric to conductive trace 18A with respect to centerline 21, conductive trace 18B is composed of conductive vias and microstrip lines 30B, 32B, and 34B at the same top two metal layers. Each microstrip might be a narrow metal strip with a substantially constant width. It is preferred to have more coupled between each conductive trace (18A or 18B) and virtually-ground patch 20. In the embodiment of FIGS. 3A and 3B, each conductive trace forms a spiral routing with more than one turns. In another embodiment, each conductive trace has a portion meandering from one end to the other at a single metal layer.

Virtually-ground patch 20 is formed under and spaced apart from conductive traces 18A and 18B. There is no direct-current conductive routing that forms and exists between virtually-ground patch 20 and anyone of conductive traces 18A and 18B.

As shown in FIG. 3B, conductive structure 22 is located between virtually-ground patch 20 and ground plane 24, composed of microstrip 36 and vias 38 and 40 to electrically couple virtually-ground patch 20 to ground plane 24. The serpent-like topology of microstrip 36 provides at least a distributed inductor, while the area where microstrip 36 overlaps with virtually-ground patch 20 or ground plane 24 forms distributed capacitors. As shown in FIG. 3B, in one embodiment, conductive structure 22 might be symmetric with respect to a central plane (not shown). For example, another conductive structure in an embodiment might have two separate conductive routes, each being symmetric to the other, and composed of a microstrip and vias.

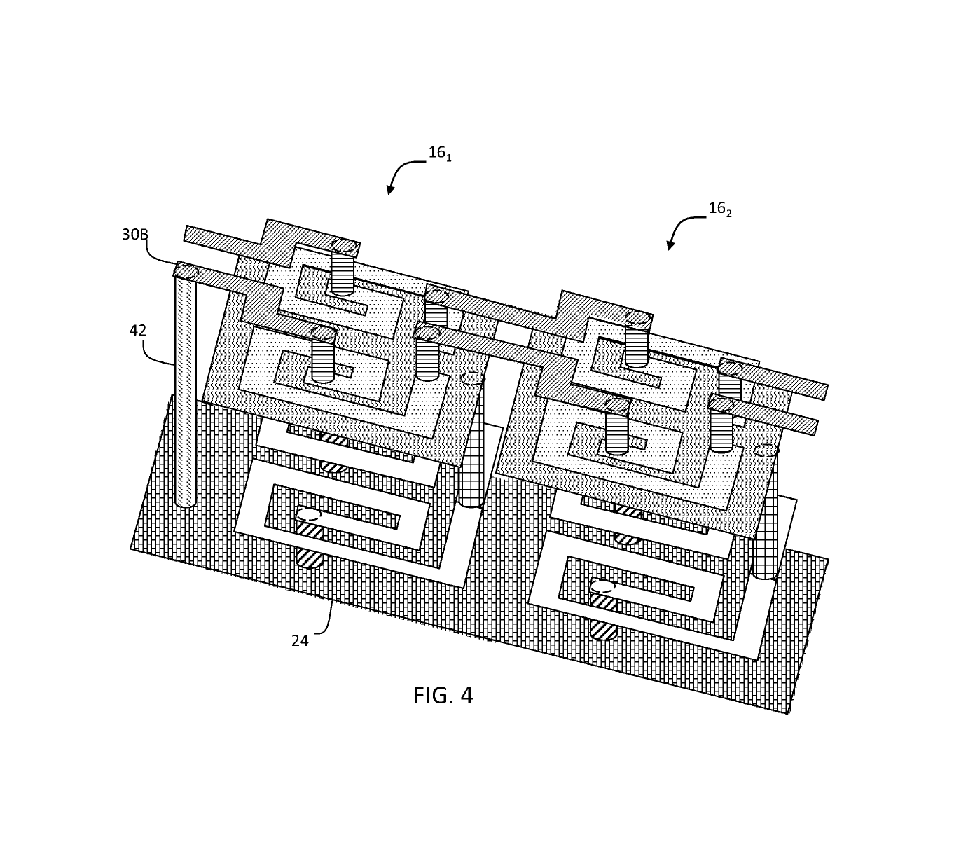

FIG. 4 demonstrates transmission cells 16₁ and 16₂. As aforementioned, transmission cell 16₁ is electrically connected to unbalanced port 12 with a ground terminal. Therefore, there is via 42 connecting microstrip 30B of transmission cell 16₁ to ground plane 24.

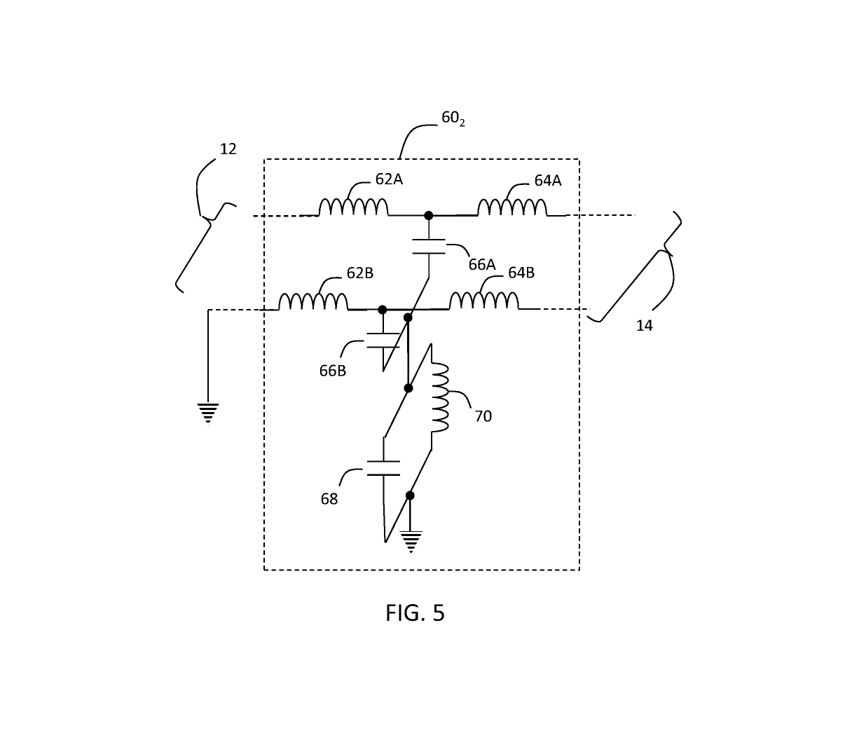

Unit-cell circuit model 60₂ with one section T-type circuit corresponding to the configuration in FIGS. 3A and 3B is established under quasi-static assumption as shown in FIG. 5. Inductors 62A and 64A and capacitor 66A correspond to conductive trace 18A, while inductors 62B and 64B and capacitor 66B to conductive trace 18B. Inductors 62A and 64A are from the distributed conductive spiral trace 18A. Capacitor 66A is attributed to the capacitive coupling between conductive trace 18A and virtually-ground patch 20. The parallel resonator associated with inductor 70 and capacitor 68 in FIG. 5 describes the interaction among virtually-ground patch 20, vias 38 and 40, microstrip 36, and ground plane 24.

The parallel resonator associated with inductor 70 and capacitor 68 is invisible for odd-mode signal analysis because virtually-ground patch 20 is deemed to be at ground voltage all the time for differential input signals. Accordingly, the input odd-mode impedance in view of the left or right two terminals of unit-cell circuit model 60₂ will be independent from inductor 70 and capacitor 68. Nevertheless, for even-mode signal analysis, the parallel resonator provides pure imaginary impedance, which varies with the frequency of signal propagating along the transmission line. Accordingly, if inductor 70 and capacitor 68 are well chosen or optimized, or if virtually-ground patch 20 and conductive structure 22 are well patterned, the parallel resonator could provide effectively negative permittivity for signals in predetermined frequency band, such that common-mode signal (or even-mode signal) in the predetermined frequency band might be uneasily transmitted through transmission cell 16₂. In other words, transmission cell 16₂ could reject common-mode noise transmission and act as an essential component in a balun.

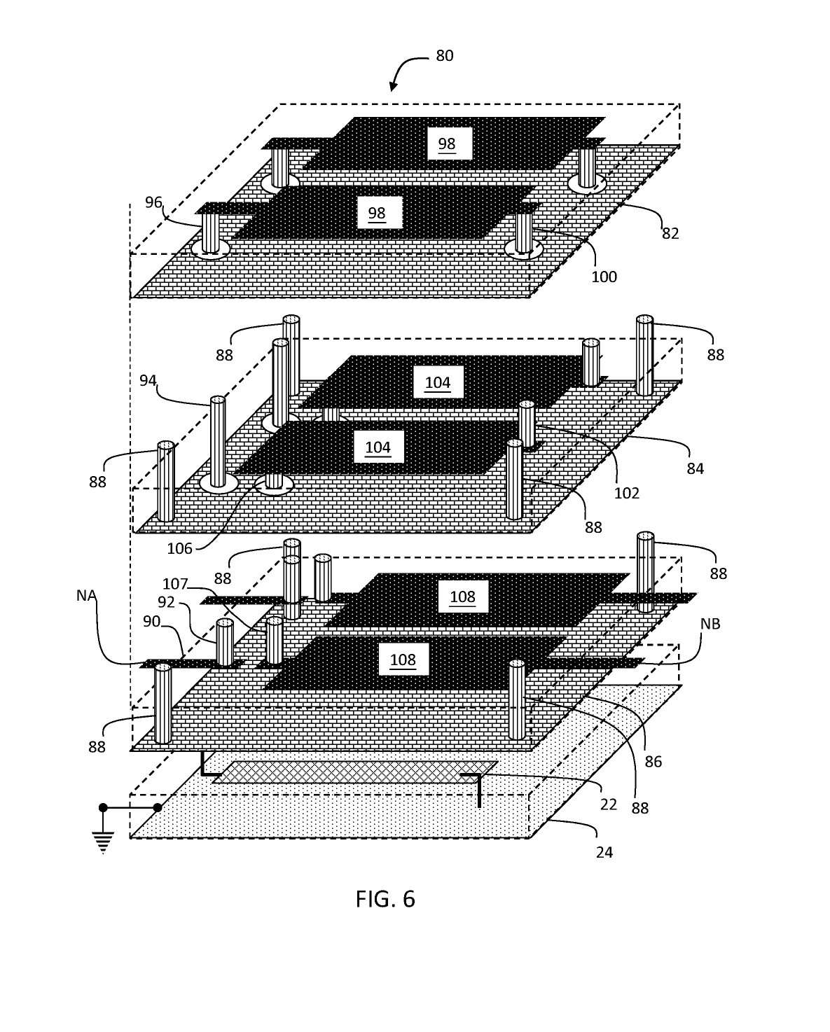

FIG. 6 demonstrates transmission cell 80 of another kind, which, in one embodiment, could embody one or more transmission cells of FIG. 1. Shown in FIG. 6 is a stacked structure, mainly comprising, from top to bottom, conductive traces 98, virtually-ground patch 82, conductive traces 104, virtually-ground patch 84, conductive traces 108, virtually-ground patch 86, conductive structure 22, and ground plane 24. Taking the transmission line with conductive traces 108 as an example, it is spaced apart from and sandwiched by virtually-ground patches 84 and 86. Virtually-ground patches 82, 84 and 86 are electrically connected or shorted to one another using vias 88. As detailed before, virtually-ground patches 86, conductive structure 22, and ground plane 24 could compose a parallel resonator that provides common-mode signal rejection. The conductive path from terminal NA to terminal NB goes through conductive trace 90, vias 92, 94 and 96, conductive trace 98, via 100 and 102, conductive trace 104, vias 106 and 107, and conductive trace 108. In comparison with the configuration of transmission cell 16₂ shown in FIG. 2, transmission cell 80 of FIG. 6 could provide a longer signal path, effectively reducing the product area or size for forming a balun.

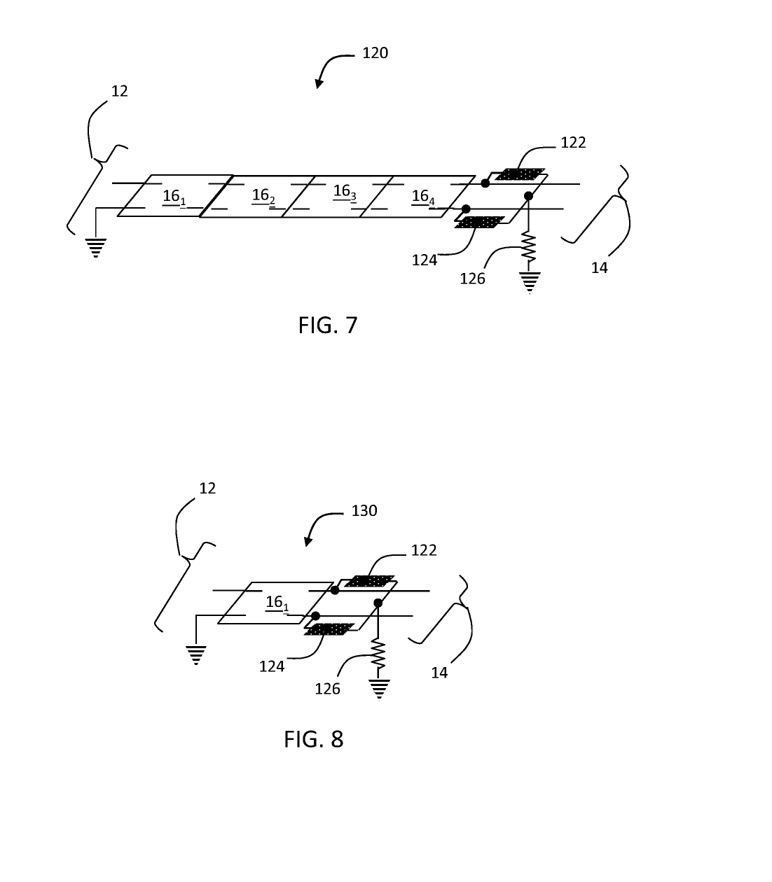

FIG. 7 demonstrates balun 120 according to another embodiment of the invention. Similar to balun 10 of FIG. 1, balun 120 has four transmission cells 16₁˜16₄ cascaded between unbalanced port 12 and balanced port 14. There is a common-mode isolator located nearby balanced port 14 to suppress the interference between the signals at two terminals of balanced port 14. In one embodiment, the common-mode isolator has two conductive traces (microstrips for instance) 122 and 124, acting as two inductors connected in series between the two balanced terminals. The common node shared by conductive traces 122 and 124 is connected to a resistor 126 and to ground, which could be ground plane 24 in anyone of transmission cell 16₁˜16₄. In one embodiment, conductive traces 122 and 124 have corresponding patterns symmetrical to each other with respect to a centerline passing through the common node.

FIG. 8 demonstrates balun 130 according to another embodiment of the invention. Balun 130 employs a single transmission cell 16₁ and the common-mode isolator with conductive traces 122 and 124 connected to balanced port 14.

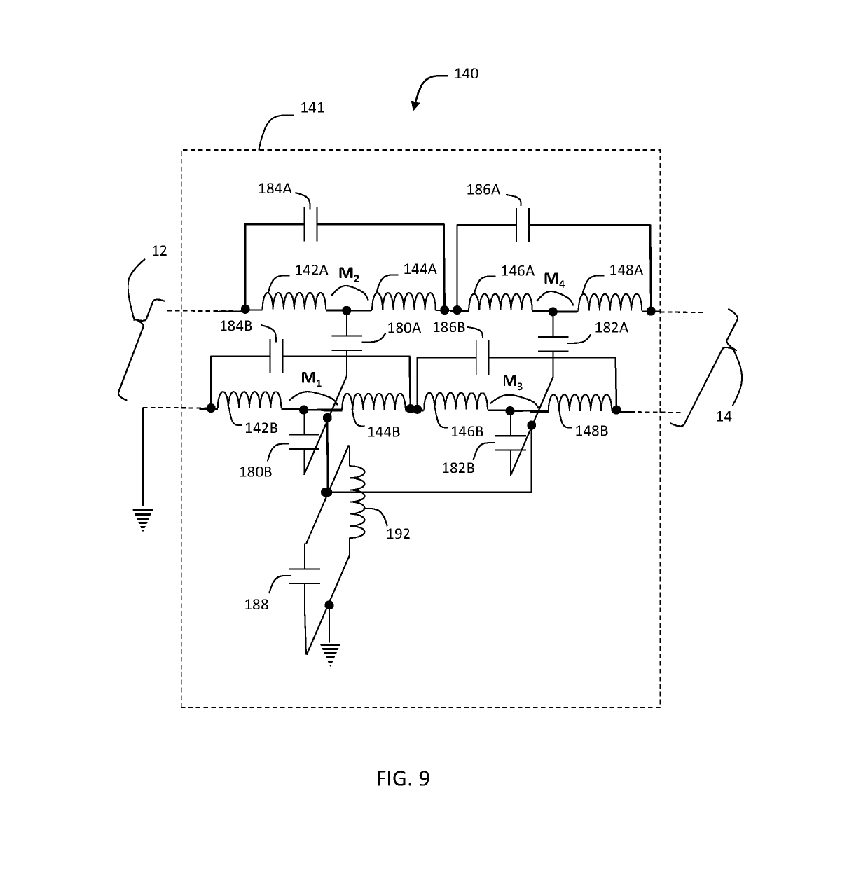

FIG. 9 demonstrates balun 140 with lumped elements according to another embodiment of the invention. Balun 140 might have one or more transmission cells 141. As shown in FIG. 9, with or without the conduction provided from other transmission cells, the two left terminals of transmission cell 141 are electrically connected to unbalanced port 12, and the two right ones to balanced port 14. In another embodiment, there are transmission cells 141 cascaded between unbalanced port 12 and balanced port 14.

Transmission cell 141 is mainly composed of lumped elements, including inductors 142A, 144A, 146A, 148A, 142B, 144B, 146B, 148B and 192, and capacitors 180A, 182A, 184A, 186A, 180B, 182B, 184B, 186B and 188. Please note that inductors 142A and 144A are inductively coupled to each other, as indicated by symbol M₂. So are inductors 146A and 148A, inductors 142B and 144B, and inductors 146B and 148B.

Transmission cell 141 has inductively-coupled inductors 142B and 144B, capacitor 184B, inductively-coupled inductors 142A and 144A, capacitor 184A, capacitor 180B and 180A. Inductors 142B and 144B are electrically connected to a common node and in series between a ground terminal and one terminal of balanced port 14. Capacitor 184B is connected to both inductors 142B and 144B. Inductors 142A and 144A are electrically connected to another common node and in series between an unbalanced terminal and the other terminal of balanced port 14. Capacitor 184A is connected to both inductors 142A and 144A. Capacitors 180A and 180B are connected to a virtually-ground node and in series between the two common nodes. Capacitor 188 and inductor 192 are connected in parallel and between the virtually-ground node and a ground. The connections of other devices in FIG. 9 are not detailed for they are self-explanatory in FIG. 9.

Please note that in transmission cell 141 have two sub-cells cascaded between unbalanced port 12 and balanced port 14. One sub-cell is the combination and interconnection of inductors 142A and 144A, inductors 142B and 144B, capacitors 184A and 184B, capacitors 180A and 180B. The other is the combination and interconnection of inductors 146A and 148A, inductors 146B and 148B, capacitors 186A and 186B, capacitors 182A and 182B.

In one embodiment, all the inductors and capacitors of the transmission cell 141 are lumped elements. In another embodiment, some inductors or capacitors of the transmission cell 141 are lumped elements while others are distributed inductors or capacitors composed by microstrips or microplates.

Capacitor 188 and inductor 192 forms a parallel LC resonator to provide pure imaginary impedance to the common-mode signal transmission between unbalanced port 12 and balanced port 14. Proper selection of capacitor 188 and inductor 192 could make transmission cell 141 a passive broadband balun.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A balun, comprising:
an unbalanced port with an unbalanced terminal and a ground terminal;
a balanced port with two balanced terminals opposite to each other in phase; and
a transmission cell, comprising:
a differential transmission line with a pair of conductive traces spaced apart from each other, the differential transmission line being electrically connected between the unbalanced port and the balanced port for transmitting a differential signal;
a virtually-ground patch spaced apart from the differential transmission line;
a ground conductor; and
a conductive structure electrically connecting the virtually-ground patch to the ground conductor.

2. The balun as claimed in claim 1, wherein the balun has transmission cells in a cascade connection, a first transmission cell being connected to the unbalanced port and a last transmission cell being connected to the balanced port.

3. The balun as claimed in claim 1, wherein the virtually-ground patch is a first virtually-ground patch, and the transmission cell further comprises:
a second virtually-ground patch, spaced apart from the differential transmission line;
wherein the first and second virtually-ground patches sandwich the differential transmission line.

4. The balun as claimed in claim 3, wherein the differential transmission line is a first differential transmission line, the transmission cell further has a second differential transmission line connected in series with the first differential transmission line; and the second differential transmission line, the second virtually-ground patch, the first differential transmission line, and the first virtually-ground patch together form a stacked structure.

5. The balun as claimed in claim 3, wherein the first and second virtually-ground patches are electrically shorted to each other.

6. The balun as claimed in claim 1, wherein each conductive trace has metal microstrips on different metal layers and vias connecting the metal microstrips.

7. The balun as claimed in claim 1, wherein the conductive structure has at least one of a metal strip and a via.

8. The balun as claimed in claim 1, wherein the conductive traces have corresponding patterns symmetrical to each other.

9. The balun as claimed in claim 1, further comprising:
a common-mode isolator, electrically connected between the two balanced terminals, the common-mode isolator comprising:
two metal strips connected to a common node and in series between the two balanced terminals; and
a resistor connected between the common node and the ground conductor.

10. The balun as claimed in claim 9, wherein the two metal strips have corresponding patterns symmetrical to each other with respect to a centerline passing through the common node.

11. The balun as claimed in claim 1, wherein the virtually-ground patch, the conductive structure, and the ground conductor provide effectively negative permittivity to common-mode noise.

12. The balun as claimed in claim 1, wherein the virtually-ground patch, the conductive structure, and the ground conductor form a stacked structure.

13. The balun as claimed in claim 1, wherein the conductive structure has a spiral structure formed between the virtually-ground patch and the ground conductor.

14. The balun as claimed in claim 1, wherein the conductive structure is symmetric with respect to a central plane.

15. The balun as claimed in claim 1, wherein the conductive structure has two separate conductive routes, each being symmetric to the other.

16. The balun as claimed in claim 1, wherein each conductive trace forms a spiral routing with at least one turn.

17. The balun as claimed in claim 1, wherein each conductive trace includes a portion meandering at a single metal layer.

18. A balun, comprising:
an unbalanced port with an unbalanced terminal and a ground terminal;
a balanced port with two balanced terminals opposite to each other in phase;
a transmission sub-cell, comprising:
first, second, third and fourth nodes, respectively electrically connected to the unbalanced terminal, the ground terminal, and the two balanced terminals;
two first inductively-coupled inductors connected to a first common node and in series between the first and third nodes;
a first capacitor connected between the first and third nodes;
two second inductively-coupled inductors connected to a second common node and in series between the second and fourth nodes;
a second capacitor connected between the second and fourth nodes; and
third and fourth capacitors connected to a virtually-ground node and in series between the first and second common nodes; and
a fifth capacitor and a grounding inductor connected in parallel between the virtually-ground node and the ground terminal.

19. The balun as claimed in claim 18, wherein the balun comprises transmission cells cascaded between the unbalanced port and the balanced port, each transmission cell comprising the transmission sub-cell, the fifth capacitor and the grounding inductor.

20. The balun as claimed in claim 18, wherein the balun has transmission sub-cells, cascaded between the unbalanced port and the balanced port; and the virtually-ground nodes of the transmission sub-cells are connected to both the fifth capacitor and the grounding inductor.

21. The balun as claimed in claim 18, further comprising:
a common-mode isolator, electrically connected between the two balanced terminals, the common-mode isolator comprising:
two metal strips connected to a common node and in series between the two balanced terminals; and
a resistor connected between the common node and the ground terminal.

22. The balun as claimed in claim 18, further comprising:
a common-mode isolator, electrically connected between the two balanced terminals, the common-mode isolator comprising:
two inductors connected to a common node and in series between the two balanced terminals; and
a resistor connected between the common node and the ground terminal.
